(19) United States
(12) Patent Application Publication
(10) Pub. No.: US 2009/0214925 A1
(43) Pub. Date: Aug. 27, 2009

(54) Fuel Cell System with a Venturi Supply of Gas

(76) Inventors: Peter Britz, Neubrandenburg (DE); Udo Martin, Hoehenkirchen (DE); Nicolas Zartenar, Essen (DE)

Correspondence Address: KRIEGSMAN & KRIEGSMAN, 30 TURNPIKE ROAD, SUITE 9, SOUTHBOROUGH, MA, 01772, US

(21) Appl. No.: 11/883,397

(22) PCT Filed: Jan. 24, 2006
(86) PCT No.: PCT/DE2006/000109

§ 371 Date: Oct. 3, 2008

(30) Foreign Application Priority Data
Jan. 31, 2005 (DE) 10 2005 004 427.1

(51) Int. Cl. H01M 2/00; H01M 8/04

(52) U.S. Cl. 429/34

(57) ABSTRACT

A fuel cell system is described wherein at least one fuel cell is supplied at least intermittently with a gas mixture, particularly one made up of a compressed oxidation gas and ambient air, which is mixed in a Venturi nozzle, whereby the compressed gas can entrain ambient air at the Venturi nozzle and can guide it or guides it to the at least one fuel cell.

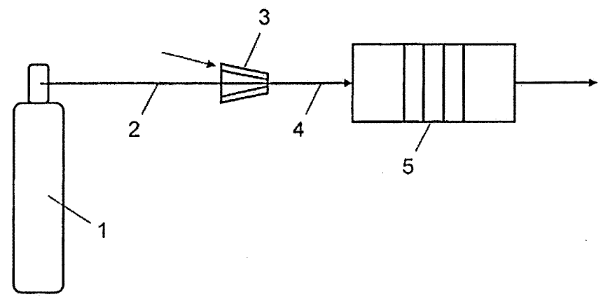

The present invention relates to a fuel cell system that is supplied at least intermittently or partially with a compressed gas, particularly a compressed oxidation gas.

Fuel cell systems have already long been known and have gained considerable importance in recent years. Like battery systems, fuel cells generate electric power via a chemical pathway by means of a redox reaction of a fuel (for example, hydrogen) and oxygen, the individual reactants being supplied continuously and the reaction products being discharged continuously.

In a fuel cell, the oxidation and reduction processes proceeding between electrically neutral molecules or atoms are usually spatially separated via an electrolyte. A fuel cell consists basically of an anode part, to which a fuel is supplied. The fuel cell further has a cathode part, to which an oxidant is supplied. The anode part and cathode part are spatially separated by the electrolyte. Such an electrolyte may involve a membrane, for example. Such membranes are capable of allowing the passage of conducting ions, but of restraining gases. The electrons released during the oxidation are not transferred locally from atom to atom, but rather conducted as electric current through a consumer.

For example, hydrogen as fuel and oxygen as oxidant in the cathode part can be used as gaseous reaction partners for the fuel cell.

If it is desired to operate the fuel cell with a readily available or more easily stored fuel, such as, for instance, natural gas, methanol, propane, gasoline, diesel, or other hydrocarbons in place of pure hydrogen, the hydrocarbon has to be initially transformed into a hydrogen-rich gas in a device for producing/processing a fuel in a so-called reforming process. This device for producing/processing a fuel consists, for example, of a metering unit having a vaporizer, a reactor for the reforming—for example, for steam reforming, a gas purification [unit], and, often, also at least one catalytic combustor for providing the process heat for the endothermic process—for example, for the reforming process.

A fuel cell system usually consists of a plurality of fuel cells, which, for example, can be formed, in turn, of individual layers. The fuel cells are preferably arranged one after the other—for example, stacked one on top of the other in a sandwichlike manner. A fuel cell system constructed in this way is then referred to as a fuel cell pile or fuel cell stack.

An important field of application for fuel cells is emergency power supply in the case of power failures for important consumers, such as, for example, data processing centers, hospitals, or telecommunication facilities. During a power failure, a fuel cell system for emergency power supply should provide the power required by the consumer being monitored within the shortest period of time. In order to bridge the start-up phase of the fuel cell system during a power interruption, the system is furnished with capacitors or batteries. A conventional system supplied by hydrogen from a compressed gas cylinder and supplied by air oxygen by a fan poses the problem that, during the system start-up of the fuel cell system, a portion of the power stored in the capacitors or batteries is consumed for supplying the air fan for providing the reaction air. Moreover, the fan requires a certain time until it provides an adequate operating pressure and volume flow. Accordingly, the capacitors or batteries have to be designed considerably larger in order to bridge the excess in power and the prolonged start-up time.

In addition, on account of the required short starting time of the fuel cell system for emergency power supply of a few seconds, the actual fuel cell elements are not heated up to the usual operating temperature. Nonetheless, even at the low operating temperatures then still existing, a secure supply of air must be assured. A main problem in doing this is to transport off the product water. There exists a relation between the dew point of the spent air and the air volume flow. At low temperatures, an in part many times higher air volume flow is required in order to prevent the air from reaching its dew point in the fuel cell, which would lead to the condensing of the product water. This condensing would, in turn, result, first of all, in the blocking of individual air channels and, subsequently, in the failure of entire cells, because what is involved is a self-enhancing effect. Relatively high pressure losses also occur at relatively high air volume flows. The design and operation of a ventilator for the entire range of the required air volume flow or pressure loss would mean that this ventilator, on the one hand, would have to be of very high capacity in order to afford or compensate for the high volume flows and pressure losses, respectively, and, on the other hand, would have to transport only very little air during normal operation—for example, at a cell temperature of about 50° C.—in order to prevent the cells from drying out too much. Accordingly, the ventilator is operated practically never at its ideal operating point.

The invention is thus based on the problem of providing an improved fuel cell system, which makes it possible to perform a start-up phase of a fuel cell without or with as little externally supplied power as possible and with an optimized air flow.

According to the invention, this problem is solved by providing a fuel cell system having the features according to the independent patent claim 1. Further advantageous configurations, aspects, and details ensue from the dependent patent claims, the description, and the attached drawing.

The invention is based on the principle of achieving the initial supply of the fuel cell system with a required compressed gas, particularly with an oxidation gas, not by means of a fan, but rather via a Venturi nozzle driven by a pressurized gas.

Accordingly, the invention is related to a fuel cell system in which at least one fuel cell is supplied at least intermittently with a gas mixture, particularly one made up of a compressed oxidation gas and ambient air, which is mixed in a Venturi nozzle, whereby the compressed gas can entrain ambient air at the Venturi nozzle and can guide it or guides it to the at least one fuel cell.

A fuel cell system is understood herein to refer to an arrangement of one or more fuel cells—for example, stacks of fuel cells or groups of such stacks together with associated auxiliary assemblies—that is required as a whole to provide a supply of power to a consumer. A compressed gas is generally understood herein to refer to a gas present at higher than atmospheric pressure. A compressed oxidation gas is understood herein to refer to a gas present at higher than atmospheric pressure that is capable of reacting oxidatively with the fuel used for the fuel cell. As a rule, the oxidative substance involves oxygen, so that the compressed oxidation gas can be oxygen gas or a mixture of oxygen gas with other gases.

A Venturi nozzle is a device known in the prior art for entraining fluids in a fluid flow by means of an underpressure produced by the fluid flow at constrictions in a tube or in a differently shaped suitable device. A known example of a Venturi device is the water-jet pump, in which a jet of water flowing in a pipe produces suction in a region of air opening into the pipe. The person skilled in the art is familiar with suitable constructions in order to use a fast flow of gas, such as the compressed oxidation gas used in accordance with the invention, to entrain a second flow consisting of ambient air.

The Venturi nozzle enables the very high pressure of the compressed gas to be transformed into an unequally larger total volume of oxidation gas, so that a relatively small amount of compressed gas is sufficient for starting up the fuel cell system. The Venturi nozzle can be arranged, for example, in a line between the gas storage source and the fuel cells. The system according to the invention also allows the amount of entrained ambient air to be controlled by regulating the pressure. In this way, it is possible to adapt the introduced amount of oxidizable gas to the operating state of the fuel cell(s).

In a preferred embodiment, the system has at least one compressed gas storage source, which contains pressurized gas, particularly oxidation gas, which can be supplied via a line to the Venturi nozzle and afterwards to the cathode side of at least one fuel cell of the system.

In another preferred embodiment, the compressed gas storage source is replaced by an external compressed gas source—for example, a compressed air supply from outside that is maintained at the required pressure via, for example, a compressor—is used in place of the compressed gas storage source. This may be appropriate, for example, for the supply of emergency power to individual functional areas or buildings for which an elevated risk for an independent power failure exists in comparison to the rest of a campus or similar situations. It is also possible to use a compressor operated by the fuel cell itself when what is involved is not an emergency power supply, but, nonetheless, on account of other advantages of the present invention, the integration of a Venturi nozzle into the system is desired.

It is further preferred that at least one valve that can control the supply of the compressed gas to the Venturi nozzle is arranged in the line. Such a valve can then be opened in order to start up a corresponding fuel cell system, for example, of an emergency power supply and to assume the quantity control of the system described above.

The valve is preferably an electrically actuated valve. In an especially preferred embodiment, the valve is an electrically actuated valve that is brought into a closed position by applying a current. In the event of a power failure, the valve opens automatically completely or to only a given extent due to the loss of voltage at the valve actuator and thereby affords the supply of compressed air without the necessity of an additional power supply. In the case of an emergency power supply that is not especially critical in terms of time, that is, for which a power failure is acceptable up to a certain period of time of, for example, several seconds, the fuel supply can be furnished with a corresponding valve, so that the system can dispense entirely with capacitors or batteries.

The valve can preferably be a check valve.

The compressed gas is preferably compressed air. This air is available as ambient air and can therefore be obtained in an especially simple manner from the surroundings. For this purpose, for example, a compressor for filling the compressed gas storage source can be linked to the compressed gas storage source and is then operated when the fuel cell system either adequately delivers power in full operating state in order to drive the compressor as well, that is, when compressed gas is no longer required, or else when the fuel cell system is not in operation, so to speak, as a measure of operational readiness.

Alternatively, the compressed gas can also be pure oxygen or an oxygen-rich gas. This gas can be stored advantageously in an appropriately designed oxygen cylinder. The use of an oxygen cylinder has the advantage that, for the reaction in the fuel cell, an even higher oxygen partial pressure is available and thus a high stack performance and accordingly an improved efficiency can be achieved.

In general, it can be advantageously provided that the compressed gas is stored in a compressed gas storage source, which is formed from at least one compressed gas cylinder. The number and size of the compressed gas cylinders ensues here from the amount of compressed gas required. The use of a compressed gas cylinder has the advantage that it can be filled at a different site and arranged in the fuel cell system in an already filled state. This further reduces the effort needed to design the fuel cell system.

Especially advantageously, the fuel cell system according to the invention described above can be used as an emergency power supply or as a component of an emergency power supply.

The present invention is now to be described in greater detail on the basis of an abstract exemplary embodiment with reference to the attached drawing, in which the following is illustrated.

The single FIGURE shows, in schematic illustration, an embodiment of the fuel cell system according to the present invention.

The solution according to the invention of the outlined problem lies in the use of a Venturi nozzle that is operated with compressed air. A compressed air tank 1 is connected via a line 2 to a Venturi nozzle 3, which mixes the compressed air from the tank 1 with ambient air (arrow) and supplies it via line 4 to the fuel cells 5.

Because the fuel cell system is not permanently required, particularly for emergency power supply, but rather only during failure of the normal power supply, it is possible during the phase with mains power supply to load a compressed air tank by means of a compressor via a line. The power consumption of the compressor does play any substantial role, because it is supplied directly from a power network of the consumer and does not appear in the power balance of the fuel cell system. Alternatively, it is also possible to use at least one compressed air cylinder. For controlling the supply of compressed gas or ambient air, respectively, via the line 2, a check valve can be arranged between the fuel cells 5 and the compressed gas tank 1.

In an exemplary calculation, a fuel cell system for 1 kW of electrical power requires approximately 1 m³/h of hydrogen and 1 m³/h of oxygen; that is, approximately 5 m³/h of ambient air. If a compressed air cylinder having the same filling volume capacity as a fuel cylinder also used for the fuel cell system—for example, a hydrogen gas cylinder—is used, 4 m³ of ambient air has to be drawn in with 1 m³ from the compressed gas cylinder. When a compressed oxygen cylinder is used, only 2.5 m³ of air has to be drawn in via the Venturi nozzle with 0.5 m³ of pure oxygen for the same oxygen amount; this affords the advantage that, on the one hand, a smaller cylinder can be used and, on the other hand, the smaller amount of air also results in an improvement in the water balance in the fuel cell stack.

When the system of the invention is properly designed, one compressed gas cylinder containing compressed gas or oxygen could be replaced via the dilution effect by the ambient air in the same time interval as the hydrogen cylinder (or other fuel) used in the system. It is possible to dispense with a complicated air-guiding system, which is necessary when fans or ventilators are used, because, owing to the higher air pressure, an equal distribution of the reaction air (oxidation gas) is substantially facilitated.

The present invention makes possible a start-up operation of a fuel cell system with minimal power input at optimal efficiency.

1. A fuel cell system in which at least one fuel cell is supplied at least intermittently with a gas mixture, particularly one made up of a compressed oxidation gas and ambient air, which is mixed in a Venturi nozzle, whereby the compressed gas can entrain ambient air at the Venturi nozzle and can guide it or guides it to the at least one fuel cell.

2. The fuel cell system according to claim 1, further characterized in that it has at least one compressed air storage source, which contains pressurized gas, particularly oxidation gas, which can be supplied via a line to the Venturi nozzle and afterwards to the cathode side of at least one fuel cell of the system.

3. The fuel cell system according to claim 2, further characterized in that at least one valve that can control the supply of compressed gas to the at least one Venturi nozzle is arranged in the line.

4. The fuel cell system according to claim 3, further characterized in that the valve is an electrically actuated valve and/or a check valve.

5. The fuel cell system according to claim 1, further characterized in that the compressed gas is compressed air.

6. The fuel cell system according to claim 5, further characterized in that the compressed air is air taken from the surroundings.

7. The fuel cell system according to claim 1, further characterized in that the compressed gas is oxygen gas or an oxygen-rich gas.

8. The fuel cell system according to claim 1, further characterized in that a compressor is linked to the compressed gas storage source for filling the compressed gas storage source.

9. The fuel cell system according to claim 1, further characterized in that the compressed gas storage source is formed from at least one compressed gas cylinder.

10. The fuel cell system according to one of claims 1 to 9, further characterized in that the fuel cell system is designed for part of an emergency power supply or as an emergency power supply.

11. Use of a fuel cell system according to claim 1 as an emergency power supply or as a component of an emergency power supply.
